(19) United States
(12) Patent Application Publication
(10) Pub. No.: US 2013/0078368 A1
(43) Pub. Date: Mar. 28, 2013

(54) FABRIC COMPRISING SHAPED CONDUCTIVE MONOFILAMENT USED IN THE PRODUCTION OF NON-WOVEN FABRICS

(71) Applicants: Jean-Louis Monnerie, Saint-Junien (FR); Pascal Debyser, Saint Yrieix (FR)

(72) Inventors: Jean-Louis Monnerie, Saint-Junien (FR); Pascal Debyser, Saint Yrieix (FR)

(73) Assignee: Albany International Corp., Albany, NY (US)

(21) Appl. No.: 13/602,972

(22) Filed: Sep. 4, 2012

Related U.S. Application Data
(63) Continuation of application No. 13/018,053, filed on Jan. 31, 2011, now abandoned.
Application No. 13/018,053 is a continuation of application No. 10/142,512, filed on May 9, 2002, now abandoned.

(51) Int. Cl. B05D 7/00

(52) U.S. Cl. CPC B05D 7/00
USPC 427/121; 118/58; 427/180

(57) ABSTRACT

In an apparatus for the production of a non-woven web, structure, or article using a spun-bonding process in combination with a forming fabric which is woven having flat CMD yarns, flat MD yarns or both with some or all of such yarns being conductive so as to dissipate static electricity.

### CROSS REFERENCE TO RELATED APPLICATION

This application is a continuation of U.S. patent application Ser. No. 13/018,053 filed Jan. 31, 2011 which is a continuation of U.S. patent application Ser. No. 10/142,512 filed May 9, 2002, now abandoned, the disclosures of which are herein incorporated by reference.

### FIELD OF THE INVENTION

The present invention is directed towards a fabric used in combination with a melt-bonding apparatus to form, transport and bond a web into a non-woven fabric.

### BACKGROUND OF THE INVENTION

There presently exists apparatus for the production of spun-bond webs, structures or articles formed from filaments or fibers typically made from a thermoplastic resin. Such an apparatus is disclosed in U.S. Pat. No. 5,814,349 issued Sep. 29, 1998, the disclosure of which is incorporated herein by reference. These typically include a spinneret for producing a curtain of strands and a process-air blower for blowing process air onto the curtain of strands for cooling the same to form thermoplastic filaments. The thermoplastic filaments are then typically, aerodynamically entrained by the process air for aerodynamic stretching of the themoplastic filaments which are then, after passing through a diffuser, deposited upon a continuously circulating sieve belt for collecting the interentangled filaments and forming a web thereon. The web, structure or article, so formed, is then subject to further processing.

Apparatus of this type, particularly for high-speed melt-bond web production are currently available from Reifenhäuser GmbH Co. Maschinenfabrik, Spicher Strabe D-53839 Troisdort, Germany and sold under the name Reicofil®. The latest generation of such high-speed spun-bond lines is referred to as the Reicofil® 3 type system.

Another manufacturer of such equipment is Nordson Corporation, 28601 Clemens Road, Westlake, Ohio 44145. Other manufacturers are STP Impianti, Rieter Perfojet, Kobelco, Ason and NWT.

During the forming process, a high air flow volume is used to deposit the fibers on the forming fabric. This air volume is drawn through the forming fabric typically by vacuum boxes positioned thereunder. Oftentimes the area around the nip of the press rolls is rendered air tight to avoid any disturbance thereabout. Typically, four press rolls are involved which are a pair of top and bottom rolls through which the forming fabric with the web thereon passes. The air volume is provided between the successive nips.

In high speed operations with high air flow, air leakage can occur between the top press roll and the forming fabric surface or through the fabric itself. Air leakage can result in undesired disturbance to the formation of the web. Excessive air carried by the fabric during web transportation may result in causing the web to flutter. The cause of such air being carried is divided between the fabric's permeability and the fabric roughness and raw material. The proportions are on the order of 80% to 20% air respectively.

Accordingly, it is desirable to minimize air leakage particularly such leakage which is caused by the movement of the forming fabric.

In addition, in a melt-bonding process (which incidentally can produce spun-bond or melt-blown or any combination of the two), there is a large amount of static electricity generated. Normally a negative charge builds up on the filaments or fibers as they are being processed. Successive layers of fibers, since they are the same polarity, tend to repel each other. Charged fibers tend to cling to the press rolls. They also tend to be repelled from the forming fabric, since it will develop a charge thereon during the processing of the charged fibers. This charge tends to accumulate.

In European Patent Application No. EP 0 950 744 A1 it proposes using press rolls having a dielectric surface which is charged with a polarity that will repel the fibers. The forming fabric is also made from a dielectric material and charged such that it is opposite to that of the fibers, thereby attracting the fibers thereto.

In summary, during the production of the non-woven web, structure or article provisions of some nature need to address the electric charges that are typically generated whether it be to dissipate them or use them in an advantageous fashion as disclosed in the aforesaid application.

### SUMMARY OF THE INVENTION

It is therefore a principal object of the invention to provide for the production of non-woven webs, structures or articles through, for example, the melt-bonding process, which minimizes air leakage, particularly that caused by the forming fabric.

It is a further object of the invention to provide for a forming fabric for the production of non-woven webs, structures or articles that minimizes or eliminates web flutter.

A yet further object of the invention is to provide for a forming fabric for use in the production of non-woven webs, structures or articles which provides for the effect of static electricity during production.

These and other objects and advantages are achieved by the present invention. In this regard the invention is directed towards generally a forming fabric for use in the production of non-woven webs, structure or articles. The forming fabric comprises a woven structure having flat monofilament yams in at least either the machine direction or cross machine direction. The use of the flat yarns in the forming fabric improve the fabric surface and decrease the empty volume in the fabric. The forming fabric may be single or multi-layered and is directed towards decreasing the disturbance caused by air whilst maintaining the desired permeability of the fabric. In addition, so as to address the static electricity problem, the flat monofilaments can be made of a conductive material which allows the dissipation of the static electricity on the web through the forming fabric to ground.

### BRIEF DESCRIPTION OF THE DRAWINGS

Thus by the present invention, its objects and advantages will be realized, the description of which should be taken in conjunction with the drawings wherein:

FIG. 1 is a schematic representation of an apparatus for making a non-woven web, structure or article such as that implementing a melt-bond process;

FIG. 2 is a side sectional schematic view of the nip of a press roll with a conventional forming fabric;

FIG. 3 is a side sectional schematic view of the nip of a press roll with a forming fabric incorporating the teachings of the present invention;

FIG. 4 is an enlarged sectional view of a conventional forming fabric taken along the machine direction of the fabric; and

FIG. 5 is an enlarged sectional view of the forming fabric of the present invention taken along the machine direction of the fabric.

### DETAILED DESCRIPTION OF THE PREFERRED EMBODIMENT

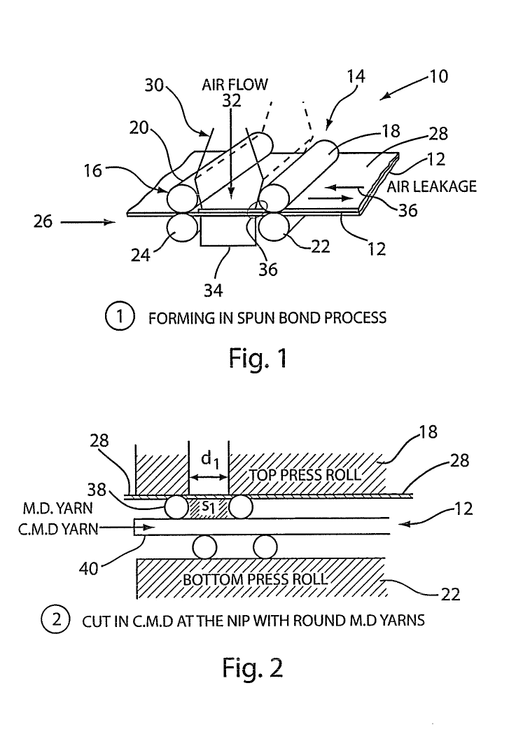

Turning now more particularly to the figures where like elements will be similarly numbered, FIG. 1 shows schematically an apparatus 10 for forming a non-woven web, structure or article. The apparatus 10 is part of a melt-bond forming machine which forms a flat web or non-woven web, structure or article by a process other than weaving. Non-woven webs, structures or articles typically comprise fibers or filaments bonded together. In general, spun-bonding involves molten polymer which is extruded from a spinning head or spinneret which produces a curtain of strands. Illustrative of such an apparatus is that set forth in U.S. Pat. No. 5,814,349. A high flow of air is used to aerodynamically stretch, elongate or attenuate the strands which, after passing through a diffuser, are deposited on a forming fabric 12. Presses are used to compress the deposit of filaments. As shown, by way of example, there are two presses, a downstream press 14 and an upstream press 16 each of which has a respective top press roll 18 and 20 and bottom press roll 22 and 24. The machine direction (MD) of the fabric 12 is indicated by arrow 26. Press 16 presses against the fabric 12 only while press 14 presses against the fabric 12 and the melt-bond web 28 formed thereon.

Intermediate the presses 14 and 16 is a melt-bonding apparatus 30 which typically includes a spinneret, blower, attenuator and diffuser which produces and deposits the filaments onto forming fabric 12. Air flow is indicated by arrow 32. Beneath apparatus 30 is a vacuum or suction box 34 which applies suction to the underside of fabric 12. The area between presses 14 and 16 may be sealed which may be in a manner as set forth in U.S. Pat. No. 5,814,349 so as to avoid any disturbance.

Air leakage can result in a disturbance of the web. As shown in FIG. 1, high air flow can result in air leakage (arrows 36) between the top press roll 18 and the fabric 12 surface or through the fabric thickness. Such air leakage is due to the excessive air carried by the fabric, the fabric surface roughness and fabric thickness. In this regard, reference is made to FIG. 2 which is a sectional view in the machine direction of fabric 12 and web 28 between rollers 18 and 22. Forming fabric 12 is a single layer woven fabric having round MD yams 38 and round cross machine direction (CMD) yarns 40. Note that the particular weave (not shown) may vary depending upon the requirements for the particular application (i.e. permeability, etc.).

As can be seen in FIG. 2, at a distance d₁ between the MD yarns 38 there exists a certain amount of empty space S₁. This empty space provides a receptacle to carry air by the fabric 12. As the speed of the melt-bonding machine (and that of the fabric) increases, air carried by the fabric during web transportation can cause the web to flutter or to follow the press roll which is undesirable, in addition to increasing the air volume and air leakage. The amount of air carried by a typical fabric used in spun-bonding is about 80% due to fabric permeability and about 20% from fabric roughness, raw material and yarn shape.

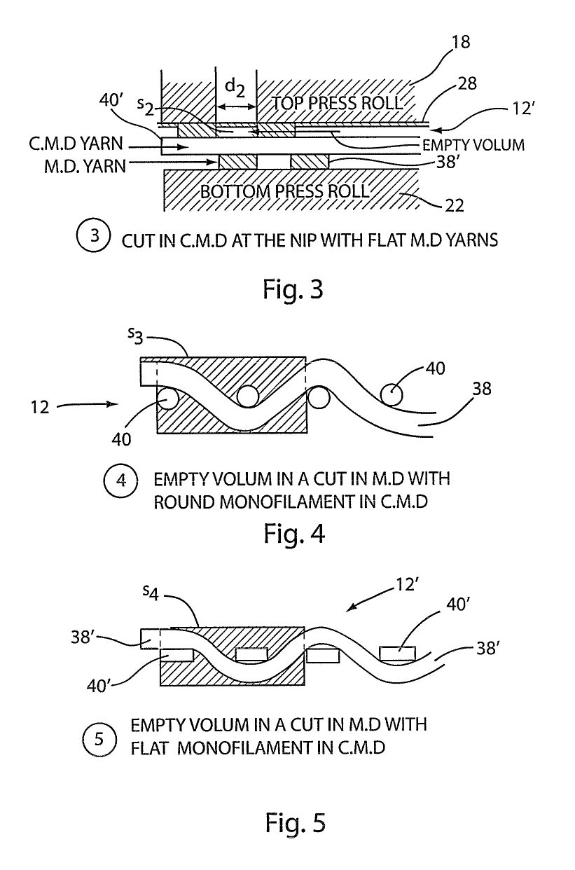

The present invention is directed towards providing in combination with a melt-bonding apparatus, a forming fabric which reduces the empty volume for carrying air and reduces the fabric roughness. In this regard, as shown in FIG. 3, is a cross section of the fabric 12′ used in the present invention. The fabric 12′ shown is a single layer woven (weave not shown) using flat MD monofilament yarns 38′ and/or flat CMD yarns 40′ as a percentage of the weave. This can be all or part of the MD yarns, CMD yarns or both and may be included in a multi-layer fabric rather than the single layer shown. The flat yarns decrease the empty volume in the fabric 12′. This decreases the amount of air carried by the fabric 12′ into the forming area and in transporting the web 20 through the nip of press 14. This reduced volume, in comparison to a fabric 12 made with all round monofilaments, can be seen by comparing the size of empty volume S₂ for distance d₂ (d₁=d₂) in FIG. 3 to S₁ in FIG. 2.

This can also be readily seen in comparing FIG. 4 to FIG. 5. in FIG. 4 there is illustrated a portion of fabric 12 along the machine direction with round monofilaments illustrated for the CMD yarns 40′. The MD yarn 38′ is shown and the empty volume is illustrated by S₃. In FIG. 5 the fabric 12′ is also illustrated along the machine direction with flat monfilaments illustrated for the CMD yarns 40′. The MD yarns 38′ may be flat monofilaments or a percentage of the machine direction yarns. As can be seen the empty volume illustrated by S₄ compared to S₃ is considerably smaller. Also, the fabric surface of fabric 12′ has a lesser degree of fabric roughness than that of fabric 12.

Note that the flat yarns have been illustrated generally. The cross section of the yarns may vary, for example, the ratio between the thickness and the width could be from 1/1 to 1/5. Also, while shown as rectangular in shape (i.e. having parallel sides), they can be barrel-shaped (i.e. parallel sides with slightly curved top and bottom) or ellipitcal shape.

As for the material used for the flat yarns, it can be any material suitable for the purpose. Note, however, as aforenoted during the operation of the melt-bonding machines, a large amount of static electricity builds up. In order to dissipate it, some of the yarns used in the fabric can be conductive. Accordingly, it is desirable that a portion of the flat CMD yarns and/or MD yarns be made of a conductive material or coated with a conductive material in order to dissipate the static electricity from the web 28 to the ground, through the fabric 12′.

Accordingly, the fabric 12′ of the present invention is a woven, single or multi-layer structure having flat CMD and/or MD with a portion of which are conductive. Such a fabric 12 reduces air disturbance during spun-bonding production whilst providing a desired permeability in the web production process.

Although a preferred embodiment has been disclosed and described in detail herein, its scope should not be limited thereby; rather its scope should be determined by that of the appended claims.

What is claimed is:

1. An apparatus for the production of a non-woven web produced by way of a melt-bonding process whereby fibers are deposited upon a forming fabric to create said non-woven web, article, or structure, wherein:
said forming fabric is woven and includes flat CMD yams or flat MD yarns so as to reduce a volume or air in the forming fabric and improve surface roughness of the forming fabric in comparison to that of a forming fabric woven out of all round yams.

2. The apparatus in accordance with claim 1 wherein the forming fabric includes flat CMD yams and flat MD yarns.

3. The apparatus in accordance with claim 1 wherein said flat CMD yarns or flat MD yarns are conductive.

4. The apparatus in accordance with claim 2 wherein said flat CMD yams and flat MD yarns are conductive.

5. The apparatus in accordance with claim 1 wherein said flat CMD yams or flat MD yarns include parallel sides with a width to height ratio being from 1/1 to 1/5.

6. The apparatus in accordance with claim 1 wherein said flat CMD yarns and flat MD yarns include parallel sides with a width to height ratio being from 1/1 to 1/5.

7. The apparatus in accordance with claim 1 wherein said flat CMD yarns or flat MD yarns are barrel shaped or elliptical shaped.

8. The apparatus in accordance with claim 1 wherein said flat CMD yarns and flat MD yarns are barrel shaped or elliptical shaped.

9. A method for the production of a non-woven web comprising the steps of:
providing a melt-bonding apparatus whereby fibers are deposited upon a forming fabric to create said non-woven web, structure, or article; and wherein said forming fabric is woven and includes flat CMD yarns or flat MD yarns.

10. The method in accordance with claim 9 wherein the forming fabric includes flat CMD yarns and flat MD yarns.

11. The method in accordance with claim 9 wherein said flat CMD yarns or flat MD yarns are conductive.

12. The method in accordance with claim 10 wherein said flat CMD yarns and flat MD yarns are conductive.
